(19) United States
(12) Patent Application Publication
(10) Pub. No.: US 2026/0017489 A1
(43) Pub. Date: Jan. 15, 2026

(54) MACHINE LEARNING ARCHITECTURE FOR TYPOSQUATTING DOMAIN NAME DETECTION

(71) Applicant: U.S. Bancorp, National Association, Minneapolis, MN (US)

(72) Inventors: Toheeb Biala, Galloway, OH (US); Charles C. Zhou, Columbus, OH (US); Bradley V. Butts, Mason, OH (US); Tommy Chin, Fairfax, VA (US); Thomas J. McKanna, St. Louis, MO (US)

(73) Assignee: U.S. Bancorp, National Association, Minneapolis, MN (US)

(21) Appl. No.: 18/767,595

(22) Filed: Jul. 9, 2024

(51) Int. Cl. G06N 3/0455; G06N 3/084

(52) U.S. Cl. CPC G06N 3/0455; G06N 3/084

(57) ABSTRACT

A system includes one or more processors to receive a base set of base domain names and a training set of training domain names; execute a plurality of similarity functions; iteratively execute a machine learning model (e.g., a neural network, an XGBoost model, a support vector machine, etc.) using the plurality of similarity values for each of the training set of training domain names; train the machine learning model; receive a candidate domain name; execute the plurality of similarity functions based on a comparison between the candidate domain name and each base domain name of the base set of base domain names; execute the trained machine learning model to generate a candidate malicious domain name prediction value for the candidate domain name; and generate a record identifying the candidate domain name and the candidate malicious domain name prediction value.

### BACKGROUND

Typosquatting, also known as uniform resource locator (URL) hijacking or domain mimicry, involves the registration of domain names that are deliberately misspelled versions of popular or well-established domain names. The intent behind typosquatting is to capitalize on user typographical errors when entering web addresses, redirecting them to malicious or unintended websites. These malicious websites often engage in phishing attacks, distribution of malware, or the promotion of fraudulent products and services, thereby exploiting the trust and familiarity associated with the targeted legitimate domains. In addition, deliberately misspelled domains are often used in phishing attempts to present a URL that appears close enough to a legitimate URL that an intended victim might not notice that the site is fraudulent.

Typosquatting poses significant risks to both internet users and legitimate domain owners. For users, the risks include exposure to identity theft, financial loss, and unauthorized access to personal information. For businesses, typosquatting can lead to brand dilution, loss of customer trust, and potential revenue loss. Additionally, the presence of typosquatted domains can complicate search engine optimization efforts.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates an example system for detecting malicious domain names, in accordance with an implementation;

FIG. 2 illustrates an example sequence for detecting malicious domain names, in accordance with an implementation;

FIG. 3 illustrates an example sequence for detecting malicious domain names, in accordance with an implementation;

FIG. 4 illustrates an example method for detecting malicious domain names, in accordance with an implementation;

FIG. 5 illustrates an example method for generating a similarity value, in accordance with an implementation;

FIG. 6 discloses a computing environment in which aspects of the present disclosure may be implemented, in accordance with an implementation; and

FIG. 7 illustrates an example machine learning framework that techniques described herein may benefit from.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Domain name typosquatting is becoming a growing problem on the Internet. Efforts to combat typosquatting have included various technical measures, such as browser warnings and domain monitoring services. However, these solutions often react to incidents of typosquatting rather than preventing them. Other solutions may use an explicit matching common pattern matching technique (e.g., regular expression/regex) of the domain names. However, these solutions require a large amount of computer resources, are often inaccurate, and can require a large amount of time. The rapid registration and proliferation of typosquatted domains necessitate more proactive and innovative approaches to mitigate this cyber threat.

A computer implementing the systems and methods described herein can address the aforementioned technical deficiencies by implementing a machine learning architecture to detect typosquatting domains with more accuracy, fewer processing resources, and less latency. The computer can do so by using a trained machine learning model (e.g., XGBoost, a neural network, a support vector machine, random forest, etc.) to use similarity values between candidate domain names (e.g., new domain names) and a list of base domain names (e.g., ground truth domain names) to detect typosquatting domains. The computer can execute similarity functions, such as a Levenshtein distance function and/or a Jaccard similarity function, to compare individual candidate domain names with the domain names of the list of base domain names to determine a similarity value for each individual candidate domain name and similarity function combination. The computer can input the similarity values, in some cases with the respective candidate domain names, into the machine learning model. The computer can execute the machine learning model based on the input to generate an output indicating whether the individual candidate domain names are malicious (e.g., typosquatting) or not, or to predict a likelihood or probability that the individual candidate domain names are malicious. By using a combination of natural language processing techniques and machine learning techniques to detect malicious domain names, the computer can provide a robust, scalable, and adaptive approach to cybersecurity by detecting malicious domain names in real-time and with improved accuracy, scalability, adaptability, and ability to handle large volumes of data, among other technical benefits.

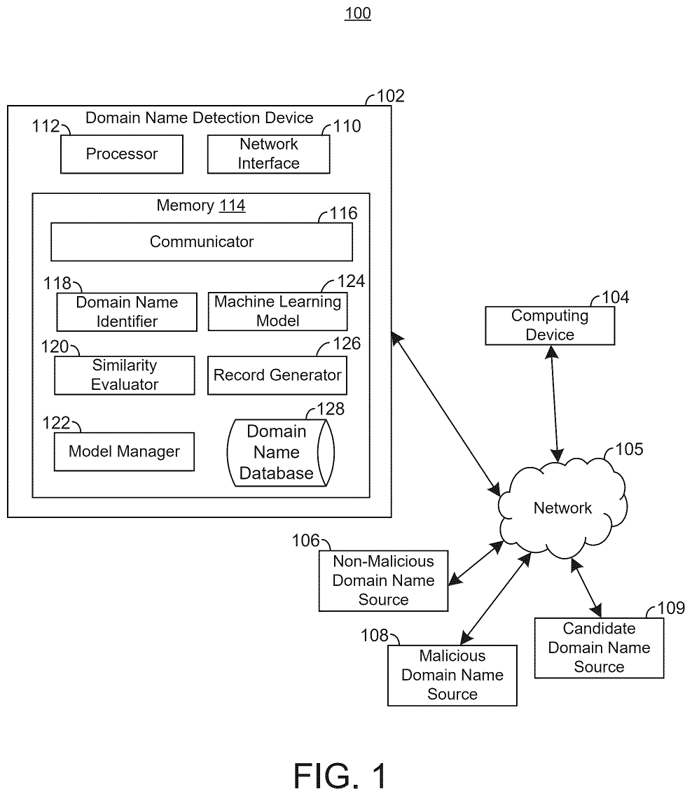

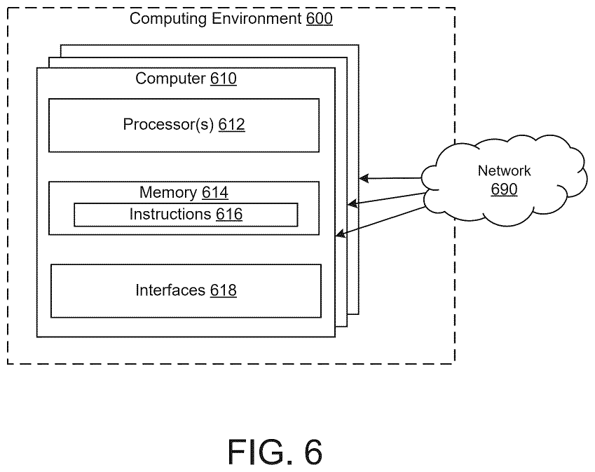

For example, FIG. 1 illustrates an example system 100 for automatic domain name detection, in accordance with an implementation. In brief overview, the system 100 can include a domain name detection device 102, a computing device 104, a non-malicious domain name source 106, a malicious domain name source 108, and/or a candidate domain name source 109. The domain name detection device 102, the computing device 104, the non-malicious domain name source 106, the malicious domain name source 108, and/or the candidate domain name source 109 can each include one or more aspects or features described elsewhere herein, such as in reference to the computing environment 600 of FIG. 6. The computing device 104 can be an administrator computing device configured to operate or configure the domain name detection device 102. The domain name detection device 102 can be configured to train and/or execute one or more similarity functions and a machine learning model to detect malicious domain names (e.g., typosquatting domain names), or suspected malicious domain names. The system 100 may include more, fewer, or different components than shown in FIG. 1.

The domain name detection device 102, the computing device 104, the non-malicious domain name source 106, the malicious domain name source 108, and/or the candidate domain name source 109 can include or execute on one or more processors or computing devices and/or communicate via a network 105. The network 105 can include computer networks such as the Internet, local, wide, metro, or other area networks, intranets, satellite networks, and other communication networks, such as voice or data mobile telephone networks. The network 105 can be used to access information resources such as web pages, websites, domain names, or uniform resource locators that can be presented, output, rendered, or displayed on at least one computing device (e.g., the domain name detection device 102, the computing device 104, the non-malicious domain name source 106, the malicious domain name source 108, and/or the candidate domain name source 109), such as a laptop, desktop, tablet, personal digital assistant, smartphone, portable computer, or speaker.

The domain name detection device 102, the computing device 104, the non-malicious domain name source 106, the malicious domain name source 108, and/or the candidate domain name source 109 can include (e.g., each include) or utilize at least one processing unit or other logic devices such as a programmable logic array engine or a module configured to communicate with one another or other resources or databases. As described herein, computers can be described as computers, computing devices, user devices, or client devices. The domain name detection device 102, the computing device 104, the non-malicious domain name source 106, the malicious domain name source 108, and/or the candidate domain name source 109 may each contain a processor and a memory. The components of the domain name detection device 102, the computing device 104, the non-malicious domain name source 106, the malicious domain name source 108, and/or the candidate domain name source 109 can be separate components or a single component. The system 100 and its components can include hardware elements, such as one or more processors, logic devices, or circuits.

The domain name detection device 102, the computing device 104, the non-malicious domain name source 106, the malicious domain name source 108, and/or the candidate domain name source 109 can each be an electronic computing device (e.g., a cellular phone, a laptop, a desktop, a server, a datacenter, a tablet, or any other type of computing device). The domain name detection device 102, the computing device 104, the non-malicious domain name source 106, the malicious domain name source 108, and/or the candidate domain name source 109 can each include a display with a microphone, a speaker, a keyboard, a touchscreen, or any other type of input/output device.

The non-malicious domain name source 106 can be or include one or more of any type of computing device or computing system configured to identify and/or store domain names available over a network (e.g., over the Internet). The non-malicious domain name source 106 can be configured to identify or store non-malicious domain names. In one example, the non-malicious domain name source 106 can store and/or update “the majestic million” dataset that includes a collection of the top one million domains ordered by the number of referring subnets. The domain names of the majestic million dataset may be valid or non-malicious domain names because they include popular domain names with high traffic. The non-malicious domain name source 106 may continuously identify and/or store domain names that are confirmed to be valid, such as by monitoring the network to identify domain names that are confirmed to be valid. In some cases, users can manually input or label domain names as valid. In some cases, the non-malicious domain name source 106 is a part of or a component of the domain name detection device 102. The non-malicious domain name source 106 can be any type of computer or data storage device that stores non-malicious domain names.

The malicious domain name source 108 can be or include one or more of any type of computing device or computing system configured to identify and/or store domain names available over a network (e.g., over the Internet). The malicious domain name source 108 can be configured to identify or store malicious domain names. In one example, the malicious domain name source 108 can store a dataset that includes a collection of domain names that have been identified, either automatically by the malicious domain name source 108 or manually by one or more users, as being malicious (e.g., typosquatting). In some cases, the malicious domain name source 108 is a part of or a component of the domain name detection device 102. The malicious domain name source 108 can be any type of computer or data storage device that stores malicious domain names.

The domain name sources 106 and/or 108 can transmit the datasets of domain names to the domain name detection device 102. For example, the non-malicious domain name source 106 can transmit a dataset of non-malicious domain names to the domain name detection device 102. The non-malicious domain name source 106 can include an indication in the dataset that the dataset includes or only includes non-malicious domain names. The malicious domain name source 108 can transmit a dataset of malicious domain names to the domain name detection device 102. The malicious domain name source 108 can include an indication in the dataset that the dataset includes or only includes malicious domain names. In some embodiments, the domain name sources 106 and/or 108 can transmit messages including domain names and/or indications of whether the domain names are malicious or not over time. In some embodiments, the domain name detection device 102 may determine which dataset or domain name is malicious or non-malicious based on the source of the dataset or domain name. The domain name detection device 102 can receive the datasets and/or domain names and store the received datasets and/or domain names in memory or in a database in memory, in some cases with the indications of whether the datasets or domain names correspond to malicious or non-malicious domain names.

The candidate domain name source 109 can be or include one or more of any type of computing device or computing system configured to identify and/or store new domain names that the candidate domain name source 109 identifies over the network 105. The candidate domain name source 109 can identify the new domain names by identifying registrations of new domain names or by detecting messages or requests to generate new domain names for the network, for example. As the candidate domain name source 109 identifies new domain names (e.g., domain names that the candidate domain name source 109 has not previously identified), the candidate domain name source 109 can transmit messages containing the new domain names as candidate domain names to the domain name detection device 102. The domain name detection device 102 can receive the domain names and use the systems and methods described herein to determine whether the new domain names are malicious or not.

The domain name detection device 102 may comprise one or more processors that are configured to train and/or use a machine learning model for malicious domain name detection (e.g., typosquatting domain name detection) and natural language processing techniques. The domain name detection device 102 may comprise a network interface 110, a processor 112, and/or memory 114. The domain name detection device 102 may communicate with the computing device 104 and/or the domain name sources 106, 108, and/or 109 via the network interface 110, which may be or include one or more antennas or other network device that enables communication across a network and/or with other devices. The processor 112 may be or include an ASIC, one or more FPGAs, a DSP, circuits containing one or more processing components, circuitry for supporting a microprocessor, a group of processing components, or other suitable electronic processing components. In some embodiments, the processor 112 may execute computer code or modules (e.g., executable code, object code, source code, script code, machine code, etc.) stored in memory 114 to facilitate the activities described herein. The memory 114 may be any volatile or non-volatile computer-readable storage medium capable of storing data or computer code.

The memory 114 may include a communicator 116, a domain name identifier 118, a similarity evaluator 120, a model manager 122, a machine learning model 124, a record generator 126, and/or a domain name database 128. In brief overview, the components 116-126 may receive a list of non-malicious domain names from the non-malicious domain name source 106 and a list of malicious domain names from the malicious domain name source 108. The components 116-126 can compare the individual domain names of each list to a base list of base domain names stored in the memory 114 of the domain name detection device 102 to determine one or more similarity values for each domain name of the two lists received from the domain name sources 106 and 108. The components 116-126 can use the similarity values and labels for the different domain names of the two lists to train a machine learning model to detect malicious domain names. The components 116-126 can then receive a candidate domain name and use a similar process of determining similarity values with the candidate domain name against the base list of base domain names. The components 116-126 can input the similarity values for the candidate domain name into the machine learning model, in some cases with the candidate domain name, and execute the machine learning model. The execution can cause the machine learning model to generate a candidate malicious domain name prediction value for the candidate domain name that indicates a likelihood that the candidate domain name is malicious. In some embodiments, the components 116-126 can use the candidate malicious domain name prediction value to determine whether the candidate domain name is malicious or not, such as by comparing the candidate malicious domain name prediction value to a threshold.

The domain name database 128 can be or include a database, such as arelational database or a graphical database. The domain name database 128 can include lists of domain names that the domain name detection device 102 receives from the non-malicious domain name source 106 and/or the malicious domain name source 108, for example. The domain name database 128 can include indications of whether the domain names are malicious or not or whether individual lists of domain names correspond to malicious domain names or not. The domain name database 128 can include any number of domain names.

In some embodiments, the domain name database 128 can include a base set of base domain names. The domain name detection device 102 can receive the base set of base domain names from the computing device 104, for example. The base set of base domain names can be ground truth domain names that the domain name detection device 102 uses to determine similarity values against training domain names for training and candidate domain names to determine whether the candidate domain names are malicious. For example, the base set of base domain names can be or include a set of domain names, or a set of one or more computer or servers, that are owned or operated by a single entity (e.g., a business). The domain name detection device 102 can use the base set to train and use a machine learning model to detect malicious domain names that are specifically directed at attacking the single entity.

The communicator 116 may comprise programmable instructions that, upon execution, cause the processor 112 to communicate with the computing device 104, one or both of the domain name sources 106, 108, and/or 109, and/or any other computing device. The communicator 116 can be or include an application programming interface (API) that facilitates communication between the domain name detection device 102 (e.g., via the network interface 110 of the domain name detection device 102) and other computing devices. The communicator 116 may communicate with the computing device 104, the non-malicious domain name source 106, the malicious domain name source 108, the candidate domain name source 109, and/or any other computing devices across a network (e.g., the network 105).

In one example, the communicator 116 can establish a connection with a computing device (e.g., the computing device 104, the non-malicious domain name source 106, the malicious domain name source 108, and/or the candidate domain name source 109). The communicator 116 can establish the connection with the computing device over the network 105. To do so, the communicator 116 can communicate with the computing device across the network 105. In one example, the communicator 116 can transmit a syn packet to the non-malicious domain name source 106 (or vice versa) and establish the connection using a TLS handshaking protocol. The communicator 116 can use any handshaking protocol to establish a connection with the non-malicious domain name source 106. The domain name detection device 102 can communicate with the non-malicious domain name source 106 over the established connection.

The components 118-122 may operate together to train the machine learning model 124 to detect malicious domain names. For example, the domain name identifier 118 may comprise programmable instructions that, upon execution, cause the processor 112 to identify different domain names from the domain name database 128. In doing so, the domain name identifier 118 can identify domain names that were received from the domain name sources 106 and/or 108 from the domain name database 128, in some cases with indications as to whether the individual domain names are malicious or not. The domain name identifier 118 can combine or group the identified domain names into a training dataset that includes the identified domain names and the indications as to whether the individual domain names are malicious or not. The indications can be labels that can be used for supervised learning to train the machine learning model 124 to detect malicious domain names. The training dataset can be or include a training set of training domain names including two subsets of training domain names, one subset of training domain names that are non-malicious (e.g., domain names from the non-malicious domain name source 106) and one subset of training domain names that are malicious (e.g., domain names from the malicious domain name source 108).

The similarity evaluator 120 may comprise programmable instructions that, upon execution, cause the processor 112 to use one or more similarity functions to determine similarity values between individual domain names. For example, the similarity evaluator 120 can be configured to execute a Levenshtein distance function to determine Levenshtein distance values between different domain names. The similarity evaluator 120 can be configured to execute a Jaccard similarity function to generate Jaccard similarity values between different domain names. In some embodiments, the similarity evaluator 120 can be configured to execute different granularities of Jaccard similarity functions, such as to generate 2-gram Jaccard similarity values, 3-gram Jaccard similarity values, 4-gram Jaccard similarity values, and/or n-gram Jaccard similarity values. The similarity evaluator 120 can be configured to execute any similarity functions to generate similarity values.

The similarity evaluator 120 can use the one or more similarity functions to generate similarity values between domain names of the training data set of training domain names and base set of base domain names. For example, the similarity evaluator 120 can execute a similarity function (e.g., the Levenshtein distance function) comparing each training domain name of the training set of training domain names with each base domain name of the base set of base domain names. In doing so, the similarity evaluator 120 can generate a set of Levenshtein distance values (e.g., preliminary Levenshtein distance values) for each of the training domain names indicating the “distance,” or number of changes that are needed for the compared domain names to be identical, between the individual training domain names and each of the base domain names. The similarity evaluator 120 can similarly execute one or more Jaccard similarity functions (e.g., Jaccard similarity functions to generate 2-gram Jaccard similarity values, 3-gram Jaccard similarity values, and/or 4-gram Jaccard similarity values) comparing each training domain name of the training set of training domain names with each base domain name of the base set of base domain names. In doing so, the similarity evaluator 120 can generate one or more sets of Jaccard similarity values (e.g., preliminary Jaccard similarity values) for each of the training domain names compared with the base set of base domain names. The similarity evaluator 120 can similarly use any similarity function to generate sets of preliminary similarity values between the training set of training domain names and the base set of base domain names.

The similarity evaluator 120 can determine, identify, or calculate similarity values from the sets of preliminary similarity values to use to train the machine learning model 124. For example, the similarity evaluator 120 can determine, calculate, or identify a similarity value for each training domain name of the training set of training domain names from a set of preliminary similarity values that the similarity evaluator 120 generates based on a comparison between the training domain name and each of the base set of base domain names according to a similarity function. The similarity evaluator 120 can determine such similarity values for each individual training domain name and for each similarity function that the similarity evaluator 120 uses to generate sets of preliminary similarity values.

The similarity evaluator 120 can determine the similarity values for individual training domain names based on or as a function of the preliminary similarity values that the similarity evaluator 120 determines for the training domain names. For example, for a training domain name of the training set of training domain names, the similarity evaluator 120 can execute a Jaccard similarity function. The similarity evaluator 120 can generate one or more preliminary Jaccard similarity values for the training domain name by executing the Jaccard similarity function comparing the training domain name and each respective base domain name of the base set of base domain names. The similarity evaluator 120 can compare the preliminary Jaccard similarity values for the training domain name with each other and determine a Jaccard similarity value for the training domain name by identifying a maximum value or by using a function (e.g., a summation function, an averaging function, a median function, etc.) on the preliminary Jaccard similarity values. The similarity evaluator 120 can similarity determine Jaccard similarity values of different granularities (e.g., 1-gram, 2-gram, 3-gram, 4-gram, n-gram, etc.) for each training domain name.

In some embodiments, the similarity evaluator 120 can determine the Jaccard similarity values as normalized Jaccard similarity values. For instance, the similarity evaluator 120 can determine the Jaccard similarity values using the function:

$$JS ( A , B ) = \frac{\vert A ⋂ B \vert}{\vert A ⋃ B \vert}$$

where A is the n-gram of a base domain name and B is the n-gram of the domain name to be examined (e.g., the training domain name). Doing so can reduce any bias involved training the machine learning model 124, such as by reducing the effect outlier data points may have on the training.

The similarity evaluator 120 can execute a Levenshtein distance function to determine a Levenshtein distance value for the training domain name of the training set of training domain names. For example, the similarity evaluator 120 can generate one or more preliminary Levenshtein distance values for the training domain name by executing the Levenshtein distance function comparing the training domain name and each respective base domain name of the base set of base domain names. The similarity evaluator 120 can compare the preliminary Levenshtein distance values for the training domain name with each other and determine a Levenshtein distance value for the training domain name by identifying a minimum value or by using a function (e.g., a summation function, an averaging function, a median function, etc.) on the preliminary Levenshtein distance values.

The similarity evaluator 120 can use any number of the similarity functions on the training domain names. In doing so, the similarity evaluator 120 can determine or calculate a set of similarity values for each training domain names.

In some embodiments, prior to executing the similarity functions on the training set of training domain names, the similarity evaluator 120 can process the training domain names. The similarity evaluator 120 can process the training domain names, for example, by removing any sub-domain and/or top-level domains (TLDs) from each training domain name of the training set of training domain names. The similarity evaluator 120 can additionally or instead remove any paths in the domain names. Cleansing the domain names in this way facilitates the domain name detection device 102 detecting malicious domain names with more accuracy, less processing power, and without taking non-relevant data into account when doing so.

In some embodiments, the similarity evaluator 120 can use 1-gram and/or 2-gram Jaccard similarity values to filter the training data set. For example, the similarity evaluator 120 can determine a plurality of preliminary similarity values for each training domain name of the training set of training domain names using the 1-gram and/or 2-gram Jaccard similarity functions. In doing so, the similarity evaluator 120 can determine normalized 1-gram and/or 2-gram Jaccard similarity values. The similarity evaluator 120 can identify a maximum preliminary similarity value for each training domain name using one or both of the 1-gram and/or 2-gram Jaccard similarity functions. The similarity evaluator 120 can compare each maximum preliminary similarity value to a threshold (e.g., 0.9). The similarity evaluator 120 can discard or otherwise not include any training domain names with at least one maximum preliminary similarity value associated with the 1-gram or 2-gram Jaccard similarity function that exceeds the threshold. Thus, the domain name detection device 102 can avoid biasing the training dataset with training domain names that have common stop words to the words that are included in the base set of base domain names.

The model manager 122 can use the sets of similarity values to train the machine learning model 124. The model manager 122 may comprise programmable instructions that, upon execution, cause the processor 112 to train and/or use the machine learning model 124 (e.g., an XGBoost model, a neural network, a support vector machine, etc.) to generate outputs indicating likelihoods that domain names are malicious or not. For example, the model manager 122 can identify individual training domain names of the training set of training domain names. The model manager 122 can identify the sets of similarity values that the similarity evaluator 120 generated for each of the training domain names. The model manager 122 can label training domain names to indicate whether they are malicious domain names or not, such as based on the source of the training domain names, as described above. The model manager 122 can feed the training domain names and corresponding labels and sets of similarity values into the machine learning model 124 for training.

For example, for each training domain name of the training set of training domain names, the model manager 122 can input the set of similarity values for the training domain name, in some cases with the training domain name itself, into the machine learning model 124. The model manager 122 may execute the machine learning model 124 based on the input to generate an output malicious domain name prediction value (e.g., a numerical value) for the training domain name that indicates a likelihood that the training domain name is a malicious domain name or not. The model manager 122 can determine a difference between the output malicious domain name prediction value and the label indicating whether the training domain name is malicious or not, such as according to a loss function. The model manager 122 can use back-propagation techniques based on the difference to adjust the internal parameters and/or weights of the machine learning model 124, such as to make it more likely that the machine learning model 124 may generate the correct output malicious domain name prediction value given the same values for the same training domain name. The model manager 122 can train the machine learning model 124 in this way using any number of training domain names.

The model manager 122 can train the machine learning model 124 until the machine learning model 124 is accurate to an accuracy threshold (e.g., a defined or predetermined value). For example, the model manager 122 can determine an accuracy of the machine learning model 124 at set intervals of training executions and/or at set time intervals. The model manager 122 can compare the accuracy to the accuracy threshold. The model manager 122 can repeat this process until determining the machine learning model 124 has an accuracy at or exceeding the accuracy threshold. Responsive to determining the machine learning model 124 has an accuracy at or exceeding the accuracy threshold, the model manager 122 can deploy the machine learning model 124 (e.g., begin using the machine learning model 124) to generate output malicious domain name prediction values for candidate domain names (e.g., new domain names).

The model manager 122 can use the machine learning model 124 to generate output malicious domain name prediction values for domain names. For example, the domain name detection device 102 can receive a candidate domain name from the candidate domain name source 109. The similarity evaluator 120 can determine a set of similarity values for the candidate domain name by comparing the candidate domain name against the base set of base domain names using one or more similarity functions (e.g., the same similarity functions that were used to generate sets of similarity values to train the machine learning model 124). The model manager 122 can input the set of similarity values for the candidate domain name, in some cases with the candidate domain name itself, into the machine learning model 124. The model manager 122 can execute the machine learning model 124 based on the input. The execution can cause the machine learning model 124 to generate a candidate malicious domain name prediction value (e.g., a numerical value) for the candidate domain name that indicates a likelihood that the candidate domain name is a malicious domain name.

The record generator 126 can generate a record identifying the candidate domain name and the candidate malicious domain name prediction value for the candidate domain name. The record generator 126 may comprise programmable instructions that, upon execution, cause the processor 112 to generate records. Records can each be or include a file, document, table, listing, message, notification, data structure, user interface, update to a user interface, etc. The record generator 126 can generate the record identifying the candidate domain name and the candidate malicious domain name prediction value responsive to the machine learning model 124 generating the candidate malicious domain name prediction value. The record generator 126 can store the record in memory 114 or in the domain name database 128.

In some embodiments, the record generator 126 can determine whether domain names are malicious, likely malicious, not malicious, or likely not malicious. The record generator 126 can do so, for example, based on malicious domain name prediction values that the machine learning model 124 generates for the domain names. For example, the record generator 126 can compare the candidate malicious domain name prediction value to a threshold (e.g., a predetermined or defined threshold, such as 0.1 or 0.10). The record generator 126 can determine the candidate domain name is malicious or likely malicious responsive to determining the candidate malicious domain name prediction value exceeds the threshold. Otherwise, the record generator 126 can determine the candidate domain name is not malicious or is likely not malicious. The record generator 126 can store an indication of the determination in the record for the candidate domain name. In some cases, the record generator 126 can generate and/or transmit an alert to the computing device 104 indicating the determination. The record generator 126 may only generate such an alert responsive to determining the candidate domain name is malicious or likely malicious. A user of the computing device 104 can view the alert and operate to mitigate or remove the domain name from the network or the Internet. Thus, the domain name detection device 102 may operate to make the network or the Internet safer by identifying and/or mitigating malicious domain names from the network or Internet.

The components 118-126 can continuously receive and process a feed of candidate domain names from the candidate domain name source 109 over time. In one example, the components 118-126 can receive and process around 20 million candidate domain names daily from the candidate domain name source 109. The components 18-126 may be able to process a high number of candidate domain names daily because the techniques described herein are fast and do not require a large amount of processing power. The data processing system can generate candidate domain name prediction values for the received candidate domain names. The data processing system can output the candidate domain name prediction values into a table that identifies the candidate domain names and the respective candidate domain name prediction values for the candidate domain names. The data processing system can generate such tables for individual time periods or continually add new candidate domain names and/or candidate domain name prediction values for the new candidate domain names to the same table. In some embodiments the record generator 126 can determine whether the respective candidate domain name prediction values exceed a threshold and include an indicator of the determinations in the table (e.g., in the same rows as the corresponding candidate domain names and the candidate domain name prediction values). The components 118-126 can transmit such tables or updates to such tables to the computing device 104 and/or store the tables or updates in memory. Accordingly, users can access the table by querying either the computing device 104 or the domain name detection device 102.

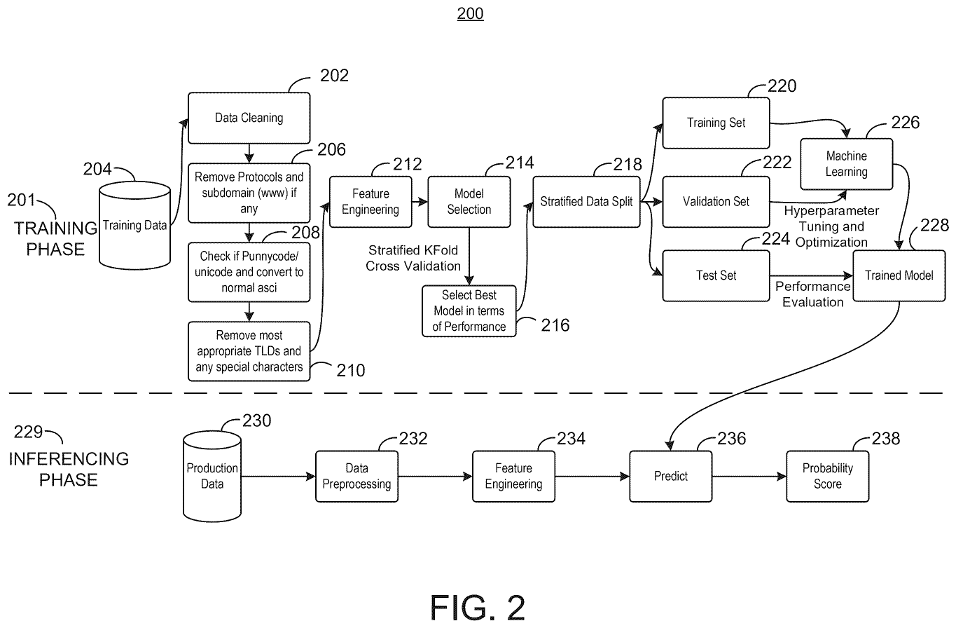

FIG. 2 illustrates a sequence diagram of a sequence 200 for detecting malicious domain names, in accordance with an implementation. The sequence 200 can be performed by the components of the system 100, shown and described with reference to FIG. 1. For example, individual operations of the sequence 200 can be performed by any of the computing devices of the system 100, shown and described with reference to FIG. 1, such as the domain name detection device 102. The sequence 200 may include more or fewer operations, and the operations may be performed in any order.

The sequence 200 can include a training phase 201 and an inferencing phase 229. The training phase 201 can involve training a machine learning model to generate malicious domain name prediction values. The inferencing phase 229 can involve using the trained machine learning model to generate malicious domain name prediction values for candidate domain names.

In the training phase 201, at an operation 202, a data processing system (e.g., the domain name detection device 102) can retrieve training domain names from a training database 204. The training database 204 can be the same as or similar to the domain name database 128, shown and described with reference to FIG. 1. The training database 204 can store domain names received from different data sources, such as a data source that identifies malicious domain names and a data source that identifies non-malicious domain names. The data processing system can label the domain names stored in the domain name database 128 as malicious or non-malicious based on the data sources from which the domain names originated.

The data processing system can retrieve training domain names from the training database 204 and begin the data cleaning process. To do so, at operation 206, the data processing system can remove protocols and/or subdomains from the retrieved domain names. At operation 208, the data processing system can check if the retrieved domain names contain any punycode or Unicode, such as by identifying the semantics of the punycode or Unicode. The data processing system can convert any domain names that contain punycode or Unicode to ascii. At operation 210, the data processing system can remove top level domains (TLDs) and/or any special characters from the domain names.

At operation 212, the data processing system can compare the training domain names to each of a base set of base domain names using one or more similarity functions. In doing so, the data processing system can generate a set of similarity values for each training domain name of the training set of training domain names.

At operations 214 and 216, the data processing system can select a machine learning model 226 model to train to generate malicious domain name prediction values. The data processing system can retrieve the selected machine learning model 226 from memory. At operation 218, the data processing system can split the training data set into a training set 220, a validation set 222, and/or a test set 224. Each of the sets 220, 222, and/or 224 can contain training domain names and corresponding sets of similarity values and labels for the training domain names. The data processing system can train the machine learning model 226 using the training set 220 such as by using back-propagation techniques and a loss function based on differences between output malicious domain name prediction values and labels for the respective training domain names of the training set 220. The data processing system can use the validation set 222 to tune the machine learning model 226. The data processing system can use the training set 220 and the validation set 222 to train and tune different hyperparameters of the machine learning model 226. The data processing system can use the test set 224 to determine if the machine learning model 226 is accurate to an accuracy threshold. Responsive to determining the machine learning model 226 is accurate to the accuracy threshold, the data processing system can deploy the machine learning model 226 as a trained machine learning model 228.

In the inferencing phase 229, the data processing system can use the trained machine learning model 228 to generate malicious domain name prediction values for candidate domain names, or new domain names. For example, the data processing system can retrieve a candidate domain name from a production database 230. At operation 232, the data processing system can process the candidate domain name by removing any top-level domains and/or sub-level domains for the candidate domain name. At operation 234, the data processing system can execute one or more similarity functions in a comparison between the candidate domain name and each base domain name of the base set of base domain names to generate one or more respective similarity values. At operation 236, the data processing system can execute the trained machine learning model 228 using the set of similarity values and/or the candidate domain name as input. The execution can cause the trained machine learning model 228 to generate a probability score 238. The probability score 238 can be a candidate malicious domain name prediction value that indicates a likelihood (e.g., on a scale, such as from 1 to 100 or 0 to 1) that the candidate domain name is a malicious domain name.

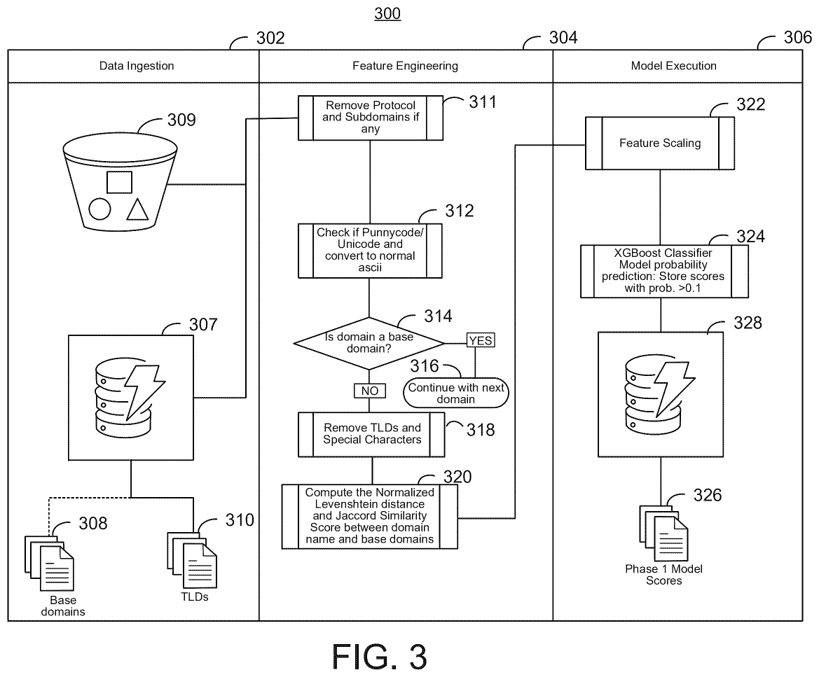

FIG. 3 illustrates a sequence diagram of a sequence 300 for detecting malicious domain names, in accordance with an implementation. The sequence 300 can be performed by the components of the system 100, shown and described with reference to FIG. 1. For example, individual operations of the sequence 200 can be performed by any of the computing devices of the system 100, shown and described with reference to FIG. 1, such as the domain name detection device 102. The sequence 300 may include more or fewer operations, and the operations may be performed in any order.

The sequence 300 can include a data ingestion phase 302, a feature engineering phase 304, and a model execution phase 306. The data ingestion phase 302 can involve receiving domain names. The feature engineering phase 304 can involve pre-processing and processing the domain names to generate a feature set to use as input into a machine learning model. The model execution phase 306 can involve executing the machine learning model using the generated feature set.

In the data ingestion phase 302, a data processing system (e.g., the domain name detection device 102) can retrieve training domain names from a base domain database 307 and candidate domain names from a candidate domain database 309. In doing so, the data processing system can retrieve base domain names 308 and/or top-level domains 310. At operation 311, the data processing system can remove protocols and/or subdomains from each of the retrieved domain names, if any. At operation 312, the data processing system can identify any domain names that have a punycode or Unicode format. The data processing system can convert such identified domain names into an ascii format. At operation 314, the data processing system can determine if any of the candidate domain names are identical or otherwise match at least one of the base domain names. Responsive to identifying at least one match, at operation 316, the data processing system may not perform any further processing on the matching candidate domain name or matching candidate domain names and proceed with the next candidate domain name.

For each non-matching candidate domain name, at operation 318, the data processing system can remove top level domains and any special characters. The data processing system can similarly remove any top-level domain and/or special characters from the base domain names. At operation 320, the data processing system can generate a set of similarity values for each of the candidate domain names. The data processing system can do so, for example, by calculating normalized Levenshtein distance and/or Jaccard similarity scores between the candidate domain names and the base domain names. The individual sets of similarity values can be or include sets of features for the individual candidate domain names.

In the model execution phase 306, at operation 322, the data processing system can scale the features of the feature sets for the candidate domain names. The data processing system can scale the features by increasing and/or decreasing the values to values that a machine learning model 324 is configured to process. The data processing system can execute the machine learning model 324 (e.g., an XGBoost classifier) using the sets of features for each of the candidate domain names as input to generate candidate malicious domain name prediction values 326 for the candidate domain names. The data processing system can store the candidate malicious domain name prediction values 326 in a domain name database 328 with identifications of the individual candidate domain names.

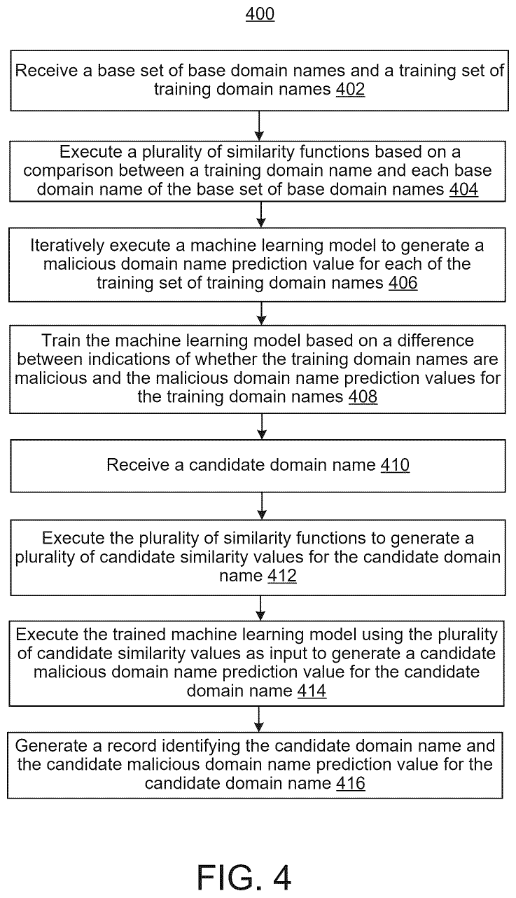

FIG. 4 illustrates an example method 400 for detecting malicious domain names, in accordance with an implementation. The method 400 can be performed by a data processing system (e.g., the domain name detection device 102, the computing device 104, the non-malicious domain name source 106, the malicious domain name source 108, and/or the candidate domain name source 109, each shown and described with reference to FIG. 1, a server system, etc.). The method 400 may include more or fewer operations and the operations may be performed in any order. Performance of the method 400 may enable the data processing system to train and use a machine learning model to detect malicious domain names (e.g., typosquatting domain names), such as malicious domain names that are targeting a specific entity or owner of a set of domain names (e.g., base domain names).

In the method 400, at an operation 402, the data processing system receives a base set of base domain names and a training set of training domain names. The base set of base domain names can be base domain names that the data processing system uses to determine whether candidate domain names are malicious or not (e.g., malicious against an entity that owns the base set of base domain names). The data processing system can receive the base set of base domain names from a computing device (e.g., an administrator computing device).

The training set of training domain names can be domain names that the data processing system uses to train, validate, and/or test a machine learning model to detect malicious domain names against the base set of base domain names. The training set of training domain names can include two subsets, a subset of malicious training domain names from a malicious domain name data source and a non-malicious subset of training domain names from a non-malicious domain name data source. The data processing system can label respective domain names with labels indicating whether the domain names are malicious or non-malicious, such as based on whether the domain names originated from the malicious domain name data source or the non-malicious domain name data source. The data processing system can include any number of training domain names from any number of data sources in the training data set.

At operation 404, the data processing system executes a plurality of similarity functions. The similarity functions can be or include different granularities of a Jaccard similarity function (e.g., 2-gram, 3-gram, 4-gram, etc.) and/or a Levenshtein distance function, for example. The data processing system can execute the similarity functions on the training domain names of the training set of training domain names. For example, for each training domain name, the data processing system can execute the plurality of similarity functions based on a comparison between the training domain name and each of the base domain names. In doing so, the data processing system can generate a plurality of preliminary similarity values for the training domain name for each of the plurality of similarity functions. The data processing system can generate and/or select a similarity value based on or from the plurality of preliminary similarity values for each of the training domain names and/or for each of the plurality of similarity functions.

For example, the data processing system can execute the Levenshtein distance function comparing a training domain name and each of the base set of base domain names to generate a plurality of preliminary similarity values for the training domain name. The data processing system can compare the plurality of preliminary similarity values between each other and identify or select the lowest preliminary similarity value. The data processing system can also execute the Jaccard similarity function comparing the training domain name and each of the base set of base domain names to generate a plurality of preliminary similarity values for the training domain name and the Jaccard similarity function. In some embodiments, the data processing system can normalize the preliminary similarity values. The data processing system can compare the plurality of preliminary similarity values for the Jaccard similarity function and identify or select the highest preliminary similarity value for the Jaccard similarity function. The data processing system can repeat this process for the different granularities of Jaccard similarity functions. The identified or selected preliminary similarity values for each similarity function together can be a set of similarity values for the training domain name. The data processing system can similarly generate sets of similarity values for each training domain name of the training set of training domain names.

At operation 406, the data processing system executes (e.g., iteratively executes) a machine learning model (e.g., an XGBoost model, a neural network, a support vector machine, a random forest, etc.) to generate one or more malicious domain name prediction values. The data processing system can generate a malicious domain name prediction value for each training domain name of the training set of training domain names. To do so, the data processing system can separately execute the machine learning model using the set of similarity values for each training domain name as input. In some cases, the data processing system can include the domain names themselves in the inputs with the corresponding sets of similarity values. The data processing system can execute the machine learning model for each of the training domain names to cause the machine learning model to generate malicious domain name prediction values for the respective training domain names. The malicious domain name prediction values can be numerical values on a scale (e.g., from 1 to 100 or 0-1) and indicate likelihoods that the respective domain names are malicious or not.

At operation 408, the data processing system trains the machine learning model using the malicious domain name prediction values that the data processing system generated for the training domain names of the training set of training domain names. The data processing system can train the machine learning model using the labels of malicious or not for the training domain names. The data processing system can determine differences between the malicious domain name prediction values generated for the training domain names and the labels of malicious or non-malicious for the respective domain names, such as by using a loss function. The data processing system can use back-propagation techniques based on the differences to adjust the internal parameters and/or weights of the machine learning model for the training domain names of the training set of training domain names. In doing so, the data processing system can train the machine learning model to detect malicious and/or non-malicious domain names.

At operation 410, the data processing system receives a candidate domain name. The data processing system can receive the candidate domain name from a data source that monitors new domain names that register with a network or the Internet, for example. The data processing system can receive the candidate domain name over the network or the Internet.

At operation 412, the data processing system executes the plurality of similarity functions. The data processing system can execute the plurality of similarity functions on the candidate domain name. The data processing system can execute the same plurality of similarity functions as the similarity functions the data processing system used to generate similarity values for the training domain names. The data processing system can execute the similarity functions based on a comparison of the candidate domain name and the individual base domain names of the base set of base domain names to generate a plurality of preliminary values for each similarity function and the candidate domain name. The data processing system can determine or select a similarity value for each of the similarity functions from the plurality of values for the similarity function, as described above. In doing so, the data processing system can generate a set of similarity values for the candidate domain name.

At operation 414, the data processing system executes the trained machine learning model. The data processing system can execute the trained machine learning model using the set of similarity values for the candidate domain name and/or the candidate domain name itself as input. Based on the execution, the machine learning model can generate a candidate malicious domain name value for the candidate domain name. The candidate malicious domain name value can indicate a likelihood that the candidate domain name is a malicious domain name.

At operation 416, the data processing system generates a record. The data processing system can generate the record such that the record identifies the candidate domain name and/or the candidate domain name prediction value for the candidate domain name. The data processing system can store the record in memory and/or transmit the record to a remote computing device. The remote computing device can receive the record and present the record or the contents of the record on a user interface. Thus, any users accessing the remote computing device can view the candidate domain name and/or the candidate malicious domain name prediction value to determine whether the candidate domain name is malicious or not. In some embodiments, the data processing system compares the candidate domain name prediction value to a threshold. Responsive to determining the candidate domain name prediction value exceeds the threshold, the data processing system can generate an alert indicating the candidate domain name is malicious. The data processing system can transmit the alert to the remote computing device for display on the user interface and/or for the remote computing device to mitigate or remove the candidate domain name from the network (e.g., from being accessible over the network), such as by blocking any network traffic identifying the candidate domain name.

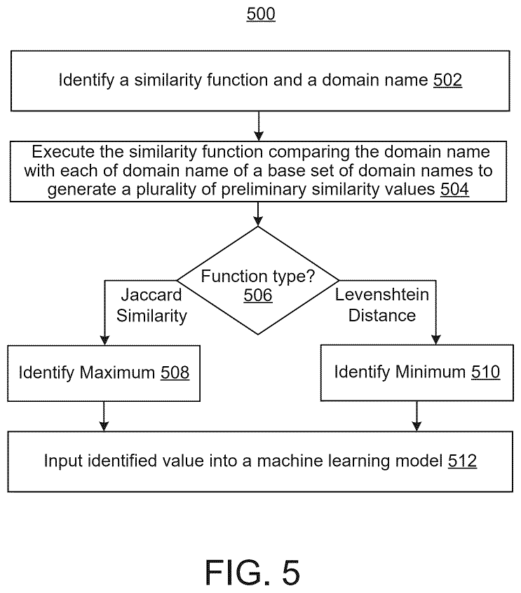

FIG. 5 illustrates an example method 500 for detecting malicious domain names, in accordance with an implementation. The method 500 can be performed by a data processing system (e.g., the domain name detection device 102, the computing device 104, the non-malicious domain name source 106, the malicious domain name source 108, and/or the candidate domain name source 109, each shown and described with reference to FIG. 1, a server system, etc.). Operations of the method 500 may be performed or correspond with operations of the method 400, such as to correspond with operations 404-408 and/or operations 412-414. The method 500 may include more or fewer operations and the operations may be performed in any order. Performance of the method 500 may enable the data processing system to identify similarity values to use as input into a machine learning model to detect malicious domain names using the systems and methods described herein.

For example, at operation 502, the data processing system can identify a similarity function and a domain name. The domain name can be a candidate domain name or a training domain name, as described herein. The similarity function can be a Jaccard similarity function of any type or a Levenshtein distance function. The data processing system can identify the similarity function and the domain name from memory.

At operation 504, the data processing system executes the similarity function. In doing so, the data processing system can compare the domain name with each base domain name of a base set of base domain names according to the similarity function. The data processing system can generate a plurality of preliminary similarity values for the domain name and similarity function based on the execution.

At operation 506, the data processing system determines a similarity function type. The data processing system can determine the similarity function type by identifying the type of the similarity function identified at operation 502. In doing so, the data processing system can determine whether the similarity function is a Jaccard similarity function or a Levenshtein distance function, for example. The data processing system can use the identified type of similarity function to determine a function or method of determining or selecting a preliminary similarity value from the plurality of preliminary values generated for the domain name and similarity function.

For example, responsive to determining the similarity function is a Jaccard similarity function, at operation 508, the data processing system can identify a maximum of the plurality of preliminary similarity values. The data processing system can compare the preliminary similarity values with each other and identify the highest preliminary similarity value to identify the maximum preliminary similarity value. The identified maximum preliminary similarity value can be a similarity value to use for further processing.

However, responsive to determining the similarity function is a Levenshtein distance function, at operation 510, the data processing system can identify a minimum of the plurality of preliminary similarity values. The data processing system can compare the preliminary similarity values with each other and identify the lowest preliminary similarity value to identify the minimum preliminary similarity value. The identified minimum preliminary similarity value can be a similarity value to use for further processing.

At operation 512, the data processing system inputs the identified preliminary similarity value into a machine learning model. The data processing system can repeat operations 502-510 for the same domain name and different similarity functions until determining a similarity value for each similarity function that the data processing system is configured to use to detect malicious domain names. In doing so, the data processing system can generate a set of similarity values for the domain name. The data processing system can input the set of similarity values, in some cases with the domain name itself, into the machine learning model and execute the machine learning model. Based on the execution, the machine learning model can output a malicious domain name prediction value for the domain name. The data processing system can repeat this process for any number of domain names.

In one aspect, the present disclosure describes a system. The system can include one or more processors of a client device. The one or more processors can be configured by machine-readable instructions stored in memory, wherein, upon execution, the machine-readable instructions cause the one or more processors to receive a base set of base domain names and a training set of training domain names, each training domain name of the training set of training domain names corresponding to an indication of whether the training domain name is malicious; execute, for each training domain name of the training set of training domain names, a plurality of similarity functions based on a comparison between the training domain name and each base domain name of the base set of base domain names to generate a plurality of similarity values for the training domain name; iteratively execute a machine learning model using the plurality of similarity values for each of the training set of training domain names as input to generate a malicious domain name prediction value for each of the training set of training domain names; train the machine learning model based on a difference between the indications of whether the training domain names are malicious and the malicious domain name prediction values for the training domain names; receive a candidate domain name; execute the plurality of similarity functions based on a comparison between the candidate domain name and each base domain name of the base set of base domain names to generate a plurality of candidate similarity values for the candidate domain name; execute the trained machine learning model using the plurality of candidate similarity values and/or the candidate domain name as input to generate a candidate malicious domain name prediction value for the candidate domain name; and generate a record identifying the candidate domain name and the candidate malicious domain name prediction value for the candidate domain name.

In another aspect, the present disclosure describes a method. The method can include receiving, by one or more processors, a base set of base domain names and a training set of training domain names, each training domain name of the training set of training domain names corresponding to an indication of whether the training domain name is malicious; executing, by the one or more processors, for each training domain name of the training set of training domain names, a plurality of similarity functions based on a comparison between the training domain name and each base domain name of the base set of base domain names to generate a plurality of similarity values for the training domain name; iteratively executing, by the one or more processors, a machine learning model using the plurality of similarity values for each of the training set of training domain names as input to generate a malicious domain name prediction value for each of the training set of training domain names; training, by the one or more processors, the machine learning model based on a difference between the indications of whether the training domain names are malicious and the malicious domain name prediction values for the training domain names; receiving, by the one or more processors, a candidate domain name; executing, by the one or more processors, the plurality of similarity functions based on a comparison between the candidate domain name and each base domain name of the base set of base domain names to generate a plurality of candidate similarity values for the candidate domain name; executing, by the one or more processors, the trained machine learning model using the plurality of candidate similarity values and/or the candidate domain name as input to generate a candidate malicious domain name prediction value for the candidate domain name; and generating, by the one or more processors, a record identifying the candidate domain name and the candidate malicious domain name prediction value for the candidate domain name.

In another aspect, the present disclosure describes non-transitory computer-readable media, comprising instructions that, when executed by one or more processors, cause the one or more processors to receive a base set of base domain names and a training set of training domain names, each training domain name of the training set of training domain names corresponding to an indication of whether the training domain name is malicious; execute, for each training domain name of the training set of training domain names, a plurality of similarity functions based on a comparison between the training domain name and each base domain name of the base set of base domain names to generate a plurality of similarity values for the training domain name; and iteratively execute a machine learning model using the plurality of similarity values for each of the training set of training domain names as input to generate a malicious domain name prediction value for each of the training set of training domain names; train the machine learning model based on a difference between the indications of whether the training domain names are malicious and the malicious domain name prediction values for the training domain names; receive a candidate domain name; execute the plurality of similarity functions based on a comparison between the candidate domain name and each base domain name of the base set of base domain names to generate a plurality of candidate similarity values for the candidate domain name; execute the trained machine learning model using the plurality of candidate similarity values and/or the candidate domain name as input to generate a candidate malicious domain name prediction value for the candidate domain name; and generate a record identifying the candidate domain name and the candidate malicious domain name prediction value for the candidate domain name.

### Large Language Models and Generative Artificial Intelligence

Large language models can be used to implement or enhance aspects described herein. As discussed above, replays, logs, or other data of user interactions with the digital experience can be captured. Such data can be provided as input to a large language model with a prompt to summarize what occurred. Such a summary can be provided as part of the remediation (e.g., to developers to better understand the problem). Further, the large language model can be prompted to identify designs or other changes that may be implemented to address the struggle. In addition to or instead of designs, the large language model may be configured to (e.g., with appropriate prompts and contacts) generate code or instructions (or changes to code or instructions) that address the struggle. A large language model may be used to generate user-specific and struggle-specific messages to the user (e.g., in relation to the above communications).

### Computing Environment

FIG. 6 discloses a computing environment 600 in which aspects of the present disclosure may be implemented. A computing environment 600 is a set of one or more virtual or physical computers 610 that individually or in cooperation achieve tasks, such as implementing one or more aspects described herein. The computers 610 have components that cooperate to cause output based on input. Example computers 610 include desktops, servers, mobile devices (e.g., smart phones and laptops), payment terminals, wearables, virtual/augmented/expanded reality devices, spatial computing devices, virtualized devices, other computers, or combinations thereof. In particular example implementations, the computing environment 600 includes at least one physical computer.

The computing environment 600 may specifically be used to implement one or more aspects described herein. In some examples, one or more of the computers 610 may be implemented as a user device, such as a mobile device, and others of the computers 610 may be used to implement aspects of a machine learning framework useable to train and deploy models exposed to the mobile device or provide other functionality, such as through exposed application programming interfaces.

The computing environment 600 can be arranged in any of a variety of ways. The computers 610 can be local to or remote from other computers 610 of the environment 600. The computing environment 600 can include computers 610 arranged according to client-server models, peer-to-peer models, edge computing models, other models, or combinations thereof.

In many examples, the computers 610 are communicatively coupled with devices internal or external to the computing environment 600 via a network 690. The network 690 is a set of devices that facilitate communication from a sender to a destination, such as by implementing communication protocols. Example networks 690 include local area networks, wide area networks, intranets, or the Internet.

In some implementations, computers 610 can be general-purpose computing devices (e.g., consumer computing devices). In some instances, via hardware or software configuration, computers 610 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 610 include one or more processors 612, memory 614, and one or more interfaces 618. Such components can be virtual, physical, or combinations thereof.

The one or more processors 612 are components that execute instructions, such as instructions that obtain data, process the data, and provide output based on the processing. The one or more processors 612 often obtain instructions and data stored in the memory 614. The one or more processors 612 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 612 include at least one physical processor implemented as an electrical circuit. Example providers processors 612 include INTEL, AMD, QUALCOMM, TEXAS INSTRUMENTS, and APPLE.

The memory 614 is a collection of components configured to store instructions 616 and data for later retrieval and use. The instructions 616 can, when executed by the one or more processors 612, cause execution of one or more operations that implement aspects described herein. In many examples, the memory 614 is a non-transitory computer-readable medium, such as random access memory, read only memory, cache memory, registers, portable memory (e.g., enclosed drives or optical disks), mass storage devices, hard drives, solid state drives, other kinds of memory, or combinations thereof. In certain circumstances, transitory memory 614 can store information encoded in transient signals.

The one or more interfaces 618 are components that facilitate receiving input from and providing output to something external to the computer 610, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors, such as those using the Global Positioning System), other input components, or combinations thereof (e.g., a touch sensitive display). The one or more interfaces 618 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as WI-FI, cellular, BLUETOOTH, ZIGBEE, or other protocols). One or more of the one or more interfaces 618 can facilitate connection of the computing environment 600 to a network 690.

The computers 610 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Machine Learning Framework

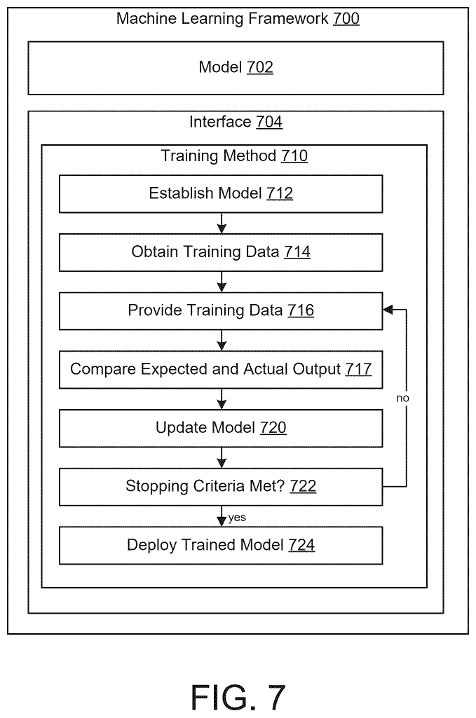

FIG. 7 illustrates an example machine learning framework 700 that techniques described herein may benefit from. A machine learning framework 700 is a collection of software and data that implements artificial intelligence trained to provide output, such as predictive data, based on input. Examples of artificial intelligence that can be implemented with machine learning ways include neural networks (including recurrent neural networks), language models (including so-called “large language models”), generative models, natural language processing models, adversarial networks, decision trees, Markov models, support vector machines, genetic algorithms, others, or combinations thereof. A person of skill in the art, having the benefit of this disclosure, will understand that these artificial intelligence implementations need not be equivalent to each other and may instead select from among them based on the context in which they will be used. Machine learning frameworks 700 or components thereof are often built or refined from existing frameworks, such as TENSORFLOW by GOOGLE, INC. or PYTORCH by the PYTORCH community.

The machine learning framework 700 can include one or more models 702 that are the structured representation of learning and an interface 704 that supports use of the model 702.

The model 702 can take any of a variety of forms. In many examples, the model 702 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 702 can include a representation of memory (e.g., providing long short-term memory functionality). Where the set includes more than one model 702, the models 702 can be linked, cooperate, or compete to provide output.

The interface 704 can include software procedures (e.g., defined in a library) that facilitate the use of the model 702, such as by providing a way to establish and interact with the model 702. For instance, the software procedures can include software for receiving input, preparing input for use (e.g., by performing vector embedding, such as using Word2 Vec, BERT, or another technique), processing the input with the model 702, providing output, training the model 702, performing inference with the model 702, fine tuning the model 702, other procedures, or combinations thereof.

In an example implementation, interface 704 can be used to facilitate a training method 710 that can include operation 712. Operation 712 includes establishing a model 702, such as initializing a model 702. The establishing can include setting up the model 702 for further use (e.g., by training or fine tuning). The model 702 can be initialized with values. In examples, the model 702 can be pretrained. Operation 714 can follow operation 712. Operation 714 includes obtaining training data. In many examples, the training data includes pairs of input and desired output given the input. In supervised or semi-supervised training, the data can be prelabeled, such as by human or automated labelers. In unsupervised learning the training data can be unlabeled. The training data can include validation data used to validate the trained model 702. Operation 716 can follow operation 714. Operation 716 includes providing a portion of the training data to the model 702. This can include providing the training data in a format usable by the model 702. The framework 700 (e.g., via the interface 704) can cause the model 702 to produce an output based on the input. Operation 718 can follow operation 716. Operation 718 includes comparing the expected output with the actual output. In an example, this can include applying a loss function to determine the difference between expected and actual. This value can be used to determine how training is progressing. Operation 720 can follow operation 718. Operation 720 includes updating the model 702 based on the result of the comparison. This can take any of a variety of forms depending on the nature of the model 702. Where the model 702 includes weights, the weights can be modified to increase the likelihood that the model 702 will produce correct output given an input. Depending on the model 702, backpropagation or other techniques can be used to update the model 702. Operation 722 can follow operation 720. Operation 722 includes determining whether a stopping criterion has been reached, such as based on the output of the loss function (e.g., actual value or change in value over time). In addition to, or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 714. If the stopping criterion has been satisfied, the flow can move to operation 722. Operation 722 includes deploying the trained model 702 for use in production, such as providing the trained model 702 with real-world input data and produce output data used in a real-world process. The model 702 can be stored in memory 614 of at least one computer 610, or distributed across memories of two or more such computers 610 for production of output data (e.g., predictive data).

### Application of Techniques

Techniques herein may be applicable to improving technological processes of a financial institution, such as technological aspects of actions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for, and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system, comprising:
one or more processors configured by machine-readable instructions stored in memory, wherein, upon execution, the machine-readable instructions cause the one or more processors to:
obtain a trained machine learning model, wherein the trained machine learning model was trained by a process including:
receiving a base set of base domain names and a training set of training domain names, each training domain name of the training set of training domain names corresponding to an indication of whether the training domain name is malicious;
executing, for each training domain name of the training set of training domain names, a plurality of similarity functions based on a comparison between the training domain name and each base domain name of the base set of base domain names to generate a plurality of similarity values for the training domain name;
iteratively executing a machine learning model using the plurality of similarity values for each of the training set of training domain names as input to generate a malicious domain name prediction value for each of the training set of training domain names;
training the machine learning model based on a difference between the indications of whether the training domain names are malicious and the malicious domain name prediction values for the training domain names;
receive a candidate domain name;
execute the plurality of similarity functions based on a comparison between the candidate domain name and each base domain name of the base set of base domain names to generate a plurality of candidate similarity values for the candidate domain name;
execute the trained machine learning model using the plurality of candidate similarity values as input to generate a candidate malicious domain name prediction value for the candidate domain name; and
generate a record identifying the candidate domain name and the candidate malicious domain name prediction value for the candidate domain name.

2. The system of claim 1, wherein the machine-readable instructions further cause the one or more processors to:
receive a first training subset of training domain names of the set of training domain names from a first data source and a second training subset of training domain names of the set of training domain names from a second data source; and
generate the training set of training domain names by combining the first training subset of training domain names and the second training subset of training domain names.

3. The system of claim 2, wherein the machine-readable instructions cause the one or more processors to generate the training set of training domain names by:
labeling each training domain name of the first training subset of training domain names as malicious based on the training domain name originating from the first data source and each training domain name of the second training subset of training domain names as non-malicious based on the training domain name originating from the second data source.

4. The system of claim 1, wherein the machine-readable instructions cause the one or more processors to execute the plurality of similarity functions based on the comparison between the candidate domain name and each base domain name of the base set of base domain names by:
executing a Levenshtein distance function between the candidate domain name and each base domain name of the base set of base domain names to generate a Levenshtein distance value for the candidate domain name; and
executing one or more Jaccard similarity functions between the candidate domain name and each base domain name of the base set of base domain names to generate one or more Jaccard similarity values for the candidate domain name,
wherein the machine-readable instructions cause the one or more processors to execute the trained machine learning model by:
executing the trained machine learning model using the Levenshtein distance value and the one or more Jaccard similarity values for the candidate domain name as input.

5. The system of claim 4, wherein the machine-readable instructions cause the one or more processors to execute the one or more Jaccard similarity functions by:
executing a plurality of Jaccard similarity function between the candidate domain name and each base domain name of the base set of base domain names to generate a 3-gram Jaccard similarity value and a 4-gram Jaccard similarity value.

6. The system of claim 5, wherein the machine-readable instructions cause the one or more processors to generate the 3-gram Jaccard similarity value and the 4-gram Jaccard similarity value by:
generating a normalized 3-gram Jaccard similarity value and a normalized 4-gram Jaccard similarity value.

7. The system of claim 4, wherein the machine-readable instructions cause the one or more processors to execute the Levenshtein distance function between the candidate domain name and each base domain name of the base set of base domain names to generate a Levenshtein distance value for the candidate domain name by:
executing the Levenshtein distance function between the candidate domain name and each base domain name of the base set of base domain names to generate a plurality of candidate Levenshtein distance values; and
selecting the Levenshtein distance value from the plurality of candidate Levenshtein distance values based on the Levenshtein distance value being a minimum of the plurality of candidate Levenshtein distance values,
wherein the machine-readable instructions cause the one or more processors to execute the machine learning model by:
executing the machine learning model using the selected Levenshtein distance value to generate the candidate malicious domain name prediction value for the candidate domain name.

8. The system of claim 4, wherein the machine-readable instructions cause the one or more processors to execute one or more Jaccard similarity functions between the candidate domain name and each base domain name of the base set of base domain names to generate a Jaccard similarity value for the candidate domain name by:
executing a Jaccard similarity function between the candidate domain name and each base domain name of the base set of base domain names to generate a plurality of candidate Jaccard similarity values; and
selecting the Jaccard similarity value from the plurality of candidate Jaccard similarity values based on the Jaccard similarity value being a maximum of the plurality of candidate Jaccard similarity values,
wherein the machine-readable instructions cause the one or more processors to execute the machine learning model by:
executing the machine learning model using the selected Jaccard similarity value to generate the candidate malicious domain name prediction value for the candidate domain name.

9. The system of claim 1, wherein the machine-readable instructions further cause the one or more processors to:
prior to executing the plurality of similarity functions on the training set of training domain names, remove any sub-domains and top level domains from each training domain name of the training set of training domain names.

10. The system of claim 1, wherein the machine-readable instructions cause the one or more processors to execute the machine learning model by executing an XGBoost model.

11. The system of claim 1, wherein the machine-readable instructions further cause the one or more processors to:
compare the candidate malicious domain name prediction value for the candidate domain name to a threshold; and
responsive to determining the candidate malicious domain name prediction value for the candidate domain name exceeds the threshold, generate an alert identifying the candidate domain name as malicious.

12. A method, comprising:
receiving, by one or more processors, a base set of base domain names and a training set of training domain names, each training domain name of the training set of training domain names corresponding to an indication of whether the training domain name is malicious;
executing, by the one or more processors, for each training domain name of the training set of training domain names, a plurality of similarity functions based on a comparison between the training domain name and each base domain name of the base set of base domain names to generate a plurality of similarity values for the training domain name; and
iteratively executing, by the one or more processors, a machine learning model using the plurality of similarity values for each of the training set of training domain names as input to generate a malicious domain name prediction value for each of the training set of training domain names;
training, by the one or more processors, the machine learning model based on a difference between the indications of whether the training domain names are malicious and the malicious domain name prediction values for the training domain names;
receiving, by the one or more processors, a candidate domain name;
executing, by the one or more processors, the plurality of similarity functions based on a comparison between the candidate domain name and each base domain name of the base set of base domain names to generate a plurality of candidate similarity values for the candidate domain name;
executing, by the one or more processors, the trained machine learning model using the plurality of candidate similarity values as input to generate a candidate malicious domain name prediction value for the candidate domain name; and
generating, by the one or more processors, a record identifying the candidate domain name and the candidate malicious domain name prediction value for the candidate domain name.

13. The method of claim 12, wherein the machine-readable instructions further cause the one or more processors to:
receiving, by the one or more processors, a first training subset of training domain names of the set of training domain names from a first data source and a second training subset of training domain names of the set of training domain names from a second data source; and
generating, by the one or more processors, the training set of training domain names by combining the first training subset of training domain names and the second training subset of training domain names.

14. The method of claim 13, wherein the machine-readable instructions cause the one or more processors to generate the training set of training domain names by:
labeling, by the one or more processors, each training domain name of the first training subset of training domain names as malicious based on the training domain name originating from the first data source and each training domain name of the second training subset of training domain names as non-malicious based on the training domain name originating from the second data source.

15. The method of claim 12, wherein executing the plurality of similarity functions based on the comparison between the candidate domain name and each base domain name of the base set of base domain names comprises:
executing, by the one or more processors, a Levenshtein distance function between the candidate domain name and each base domain name of the base set of base domain names to generate a Levenshtein distance value for the candidate domain name; and
executing, by the one or more processors, one or more Jaccard similarity functions between the candidate domain name and each base domain name of the base set of base domain names to generate one or more Jaccard similarity values for the candidate domain name,
wherein the machine-readable instructions cause the one or more processors to execute the trained machine learning model by:
executing, by the one or more processors, the trained machine learning model using the Levenshtein distance value and the one or more Jaccard similarity values for the candidate domain name as input.

16. The method of claim 15, wherein executing the one or more Jaccard similarity functions comprises:
executing, by the one or more processors, a plurality of Jaccard similarity function between the candidate domain name and each base domain name of the base set of base domain names to generate a 3-gram Jaccard similarity value and a 4-gram Jaccard similarity value.

17. The method of claim 16, wherein generating the 3-gram Jaccard similarity value and the 4-gram Jaccard similarity value comprises:
generating a normalized 3-gram Jaccard similarity value and a normalized 4-gram Jaccard similarity value.

18. The method of claim 15, wherein executing the Levenshtein distance function between the candidate domain name and each base domain name of the base set of base domain names to generate a Levenshtein distance value for the candidate domain name comprises:
executing, by the one or more processors, the Levenshtein distance function between the candidate domain name and each base domain name of the base set of base domain names to generate a plurality of candidate Levenshtein distance values; and
selecting, by the one or more processors, the Levenshtein distance value from the plurality of candidate Levenshtein distance values based on the Levenshtein distance value being a minimum of the plurality of candidate Levenshtein distance values,
wherein executing the machine learning model comprises:
executing, by the one or more processors, the machine learning model using the selected Levenshtein distance value to generate the candidate malicious domain name prediction value for the candidate domain name.

19. Non-transitory computer-readable media comprising instructions that, when executed by one or more processors, cause the one or more processors to:
receive a base set of base domain names and a training set of training domain names, each training domain name of the training set of training domain names corresponding to an indication of whether the training domain name is malicious;
execute, for each training domain name of the training set of training domain names, a plurality of similarity functions based on a comparison between the training domain name and each base domain name of the base set of base domain names to generate a plurality of similarity values for the training domain name; and
iteratively execute a machine learning model using the plurality of similarity values for each of the training set of training domain names as input to generate a malicious domain name prediction value for each of the training set of training domain names;
train the machine learning model based on a difference between the indications of whether the training domain names are malicious and the malicious domain name prediction values for the training domain names;
receive a candidate domain name;
execute the plurality of similarity functions based on a comparison between the candidate domain name and each base domain name of the base set of base domain names to generate a plurality of candidate similarity values for the candidate domain name;
execute the trained machine learning model using the plurality of candidate similarity values as input to generate a candidate malicious domain name prediction value for the candidate domain name; and
generate a record identifying the candidate domain name and the candidate malicious domain name prediction value for the candidate domain name.

20. The non-transitory computer-readable medium of claim 19 wherein execution of the instructions further cause the one or more processors to:
receive a first training subset of training domain names of the set of training domain names from a first data source and a second training subset of training domain names of the set of training domain names from a second data source; and
generate the training set of training domain names by combining the first training subset of training domain names and the second training subset of training domain names.
